(19) United States
(12) Patent Application Publication
(10) Pub. No.: US 2010/0217708 A1
(43) Pub. Date: Aug. 26, 2010

(54) Superior identification system using numbers

(76) Inventor: Arthur Vanmoor, Miami, FL (US)

Correspondence Address: Hoffman, Wasson & Gitler, P.C.;Suite 522, 2461 South Clark Street, Arlington, VA, 22202, US

(21) Appl. No.: 12/453,128

(22) Filed: Apr. 29, 2009

Related U.S. Application Data
(60) Provisional application No. 61/202,413, filed on Feb. 26, 2009.
(60) Provisional application No. 61/202,769, filed on Apr. 2, 2009.

(51) Int. Cl. G06Q 20/00; G06F 21/00

(52) U.S. Cl. 705/44; 726/9

(57) ABSTRACT

A system and method of preventing unauthorized use of a credit/debit card whereby a new PIN code is used for each new transaction. The user/card holder is in charge of generating each new PIN code. When entering the PIN code, a new PIN code is entered at the same time which replaces the last PIN code. Since only the user/card holder knows this ever changing new PIN code, this system is virtually fraud proof. In an enhanced version intercepting the new PIN code or watching what digits are used by the card holder would be worthless since a secret number only known by the card holder would have to be added to the last PIN code when used for the next transaction.

### CROSS-REFERENCE TO RELATED APPLICATIONS

The present application claims the benefit of U.S. Provisional Patent Application Ser. No. 61/202,413, filed On Feb. 26, 2009, as well as U.S. Provisional Patent Application Ser. No. 61/202,769, filed on Apr. 2, 2009. The subject matter of both provisional patent applications are incorporated by reference herewith.

### BACKGROUND OF THE INVENTION

The present invention relates to an identification system using only numbers. This could be used to enter a secured area or for debit/credit card, charge card or any other financial transactions. Most widely used is a similar system in the credit/debit card industry. However, these existing systems are very receptive to fraud. The present invention has overcome these problems.

At present, when a credit card or debit card transaction is made at a merchant's place of business, the merchant would slide the credit card or debit card through a terminal. Additionally, particularly when a credit or debit card is used at an ATM location, the owner of the card would input a personal identification number (PIN). The terminal would then automatically dial a toll free number connecting the terminal to a computer at a computer center. The computer would automatically check the available balance of the card as well as to verify the ownership utilizing the PIN. The computer at the computer center would contact the merchant's terminal with either an approval code or an indication that the transaction has been declined. It is noted that this system is vulnerable to fraud, stolen cards or copycat cards. Consequently, if a thief has absconded with an individual's credit or debit card and is in possession of that individual's PIN, the credit card could be utilized to conduct a rather large number of transactions as well as, with respect to a debit card, drain the individual's bank account.

Consequently, a number of U.S. patent applications have been filed and patents have issued on various systems to make it difficult or impossible for a thief to effectively utilize an individual's stolen credit or debit card.

For example, U.S. Pat. No. 5,478,994, as well as U.S. Pat. No. 5,627,855, both issued to Rahman et al describes a system utilizing a credit card including a programmable read only memory (PROM) containing a series of stored randomly generated numbers, each number representing a unique PIN, each PIN used for only a single transaction. A host computer is provided with the same identical PINs as included on the PROM. Therefore, when a transaction is made, one of the PIN numbers is transmitted to the host computer which verifies that the transaction is valid based upon a comparison of the transmitted PIN with one of the PINs included in the memory of the host computer.

U.S. Pat. No. 5,251,259, issued to Mosley, illustrates a personal identification system for use with a credit card. A group of seven PINs are assigned to each card holder. This series of PINs would be maintained in a PIN memory provided in the computer at the credit card company. If a PIN is used out of sequence, the access to the credit card would be denied by the credit card company.

U.S. Pat. No. 7,051,929, issued to Li, details a secure credit card employing a security number changed on a daily basis. A process is provided on the credit card loaded with a predetermined program to generate the proper security number. A computer provided at the credit card company would also maintain this predetermined program for computing the security number which is compared to the security number generated and transmitted to the credit card company.

U.S. Patent Application Publication No. 2004/0241183, as well as U.S. Pat. Nos. 7,246,752; 7,380,710 and 7,472,829, all in the name of Brown, describe a system in which a new PIN code is provided for every transaction.

U.S. Pat. Nos. 7,448,538 and 7,472,827, issued to Fletcher, illustrate a system in which a limited use PIN is associated with a primary account.

None of the references describes a concept whereby the user/card holder himself generates and chooses each next new PIN code to be used. The prior art is still subject to fraud because either the credit card gets stolen with the secret information on the magnetic strip, or the same PIN code is re-occurring in some way.

### SUMMARY OF THE INVENTION

The present invention overcomes the deficiencies of the prior art by providing an individual with a system allowing the individual to utilize a credit or debit card with confidence that, if that card or the credit card number is stolen, it would be impossible for the thief to effectively utilize the card to the detriment of the card owner or the issuing bank. Each time the credit or debit card or the numbers for instance on line are used, a PIN code needs to be used. Therefore, the present invention uses a PIN code that is constantly changing and generated and chosen by the user/card holder. Every time the PIN code is requested for a purchase, the user enters or supplies the next PIN code he/she wants to be used for the next transaction. In an enhanced version, the next new PIN code to be generated must be used in combination with a formula such as adding a secret digit or digits. This version prevents fraudulent uses in cases in which the next new PIN code is in position of an unauthorized user. Only the true user/card holder knows the new PIN code an the secret digit or digits.

In a simplified version without the use of a secret digit, or a formula, the following example is illustrative of the invention. If the initial PIN is 454, then the PIN to be used at the first merchant is 454. At the same time, the next new PIN must be then conveyed to the credit card company or bank's database for storage therein. In this example, if the next PIN to be chosen is 853, then 853 can be entered in two different ways. One manner of entering this number would be to combine the previous PIN with the new PIN as one number. In this example, this would be done by inputting 454853 at one time. Alternatively, this can be done by inputting 454 first and then to wait or pause for a command and then enter 853. Using this scenario, wherein the user employs new numbers as a random PIN, the numbers could be entered either all at once or with a pause as follows: 853-345. The next transaction would be 345-777. The following transaction would be 777-271. The following transaction would be 271-444. The next transaction would be 444-855 and so on.

The present invention insures the safety of any transaction conducted at a merchant's terminal, over the internet, or by phone by requiring that an individual card owner pick a secret digit or digits which would be utilized in a certain manner, for instance by adding this to the initial PIN code. In this scenario, the card holder when applying for the issuance of a card would supply the credit card company or a bank with this secret digit or digits. The credit card company would then supply the card holder with an initial PIN along with the credit or debit card. Thereafter, when the card holder makes an initial purchase, the card holder would enter the initial PIN and add the secret digit or digits, thereby creating a new and matching PIN. At the bank/credit card center, this new PIN would be compared with the combination of the initial PIN and the card holder's secret digit or digits. If there is a match between the combination of the initial PIN and the secret digit or digits which is computed as a new PIN in the computer's memory, the transaction would be consummated.

When the card holder enters his new PIN code, which is the last one used, plus the added secret digit or digits at the same time, the next new PIN is entered. At the computer center, the secret digit gets added and this new PIN would then be entered into the computer's memory. Thereafter, when the card holder wishes to make another purchase, the card holder would enter the combination of the last PIN added with the secret digit or digits. If the comparison indicates that the new PIN (including the secret digit or digits) agrees with the numbers stored in the database, the transaction would be consummated. In this manner, if a thief steals the card owner's credit or debit card, it would be useless since even if they were in possession of the initial PIN code generated by the credit card company prior to any purchases being made, it would be virtually impossible for the thief to enter the combination of the last PIN used and the secret digit or digits. Additionally, it would be virtually impossible for the thief to match any subsequent numbers entered into the system by the card owner and no purchases would then be approved.

As can be appreciated, while the present invention would prevent fraudulent purchases to be made, for the system to work properly, it is important that the card user remember the secret digit or digits and the formula used such as adding as well as the last random PIN that was entered. These numbers should either be memorized by the card user or written down. It does not matter if a thief becomes in possession of the credit card and/or its numbers and the PIN because it is worthless as long as the thief does not know the secret digit or digits. Since these secret digits are never given to anyone (only initially to set up the card with the bank), there is now way a thief can get in possession of them. This system is virtually 100% fraud proof. It does not matter whether a camera is spying on the terminal when the card holder enters the numbers and PIN numbers. Without the secret digit or digits, any future transaction would fail to make a match since only at the database memory is the correct true PIN on file. For the secret digits, one could choose a birthday from someone or a lucky number, or any other significant number.

For example, if the secret digit is 8 and the formula is “adding” with a starting PIN of 558, then the card holder should use a PIN 564 (558+8) in order to obtain a match with the PIN stored in the database of the computer center associated with the bank or credit card company. The user would then transmit a new PIN to the database by entering the old PIN along with a new random PIN. In this example, if the new random PIN is chosen to be 212, then the user would enter 561-212 as a single input or with a pause between the old PIN and the new PIN. For instance, the 212 could be entered when the terminal states a command or request to do so. In a preferred embodiment, this could be done all at once such as 564212 or with a dash (—) or any other keyboard symbol such as a star (*). Subsequent transactions would be, for example, 220-555. The next transaction would be 563-947. The following transaction would be 953-888. The next transaction would be 896-707. The following transaction would be 715-484 and so on. It is noted that an 8 was added to all of the new PINs.

### BRIEF DESCRIPTION OF THE DRAWING

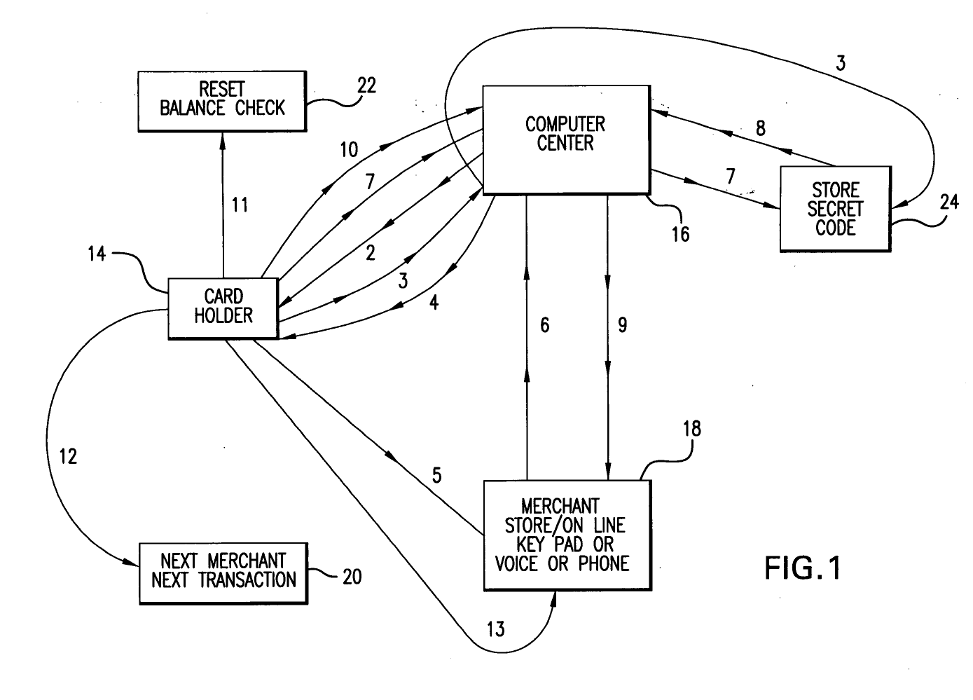

The present invention is described with respect to FIG. 1 which illustrates a block diagram of the system according to the present invention.

### DETAILED DESCRIPTION OF THE PRESENT INVENTION

FIG. 1 illustrates the system which is utilized with the present invention. This diagram includes the various principles that are needed as well as illustrating the steps involved in practicing the present invention. Initially, an individual 14 who wishes to obtain a debit or credit card would request an application at Step 1 from a credit card company 16. This application would be requested in many ways such as receiving a solicitation in the mail, or actively asking the credit card company via the internet or a telephone request to send an application for a credit card or debit card to the potential card holder 14. This application would then be sent by the credit company and received by the card holder at Step 2. The card holder would then complete the application and send it back to the credit card company at Step 3. It is important that in the application a request is made for a preferred and easy to remember secret digit or digits and the preferred choice of formula, for instance, adding, that would be utilized along with either an initialized PIN generated by the credit card company and sent to the card holder or utilizing an initialized PIN created by the card holder and sent to the credit card company. The credit card company 16 would then send the credit or debit card to the card holder 14 at Step 4. If the credit card company 16 created the initial PIN, both that initial PIN as well as the secret digit or digits and formula of choice would be provided to the credit card company 16 by the card holder 14 would be stored in a computer 24 in communication with the credit card company 16. If the credit card company 16 did not provide the initial PIN to the credit card holder 14, this initial PIN would also be generated by the card holder 14 and transmitted to the credit card company 16 where it would be stored in the computer 24 along with the secret digit or digits and the formula, for instance, adding.

In one alternative of the present invention, the card holder can now use the initial or lastly generated PIN to make a purchase at a merchant's establishment 18, either in person utilizing a key pad, or through the internet or a telephone call at Step 5. At this point, the card holder would input or supply the new PIN code. This new PIN code is the combination, for instance, adding, from the last entered (or started) PIN with the added secret digit or digits. At the same time, a new PIN code is also entered which will be the basis for the next future transaction. Again, the last PIN code needs to be used in the future by simply adding the secret digit or digits to it. If the transaction was made at the merchant's place of business, the card holder's credit or debit would be swiped at a terminal. If the purchase was made by telephone, the card holder would either enter the card number using his or her keypad or the number would be entered verbally with the PIN code and new PIN. Similarly, if an internal purchase were made, the card number would be entered using a computer keypad. After a purchase, the card holder 14 would then proceed to the next merchant at 18 and enter the last PIN added with the secret digit or digits. The combination of the PIN and the secret digit or digits would then be transmitted to the computer company at Step 6. The credit card company 16 would then transmit the PIN to the computer 24 to compare this number with the combination of the last PIN added with the secret digit or digits stored in the computer at Step 7. If there is a match, Step 8 would then transmit the approval to the credit card company 16 and if approval is warranted because there are funds available, approval would then be transmitted to the merchant 18 would inform the card holder that the transaction has been consummated. If no match is made, the credit card company would inform the merchant that the transaction cannot be consummated.

Once approval has been given to the card holder 14 from the merchant 18, the card holder 14 can transmit to the computer center 16 and the computer 24 a new PIN entered into the computer at Step 9. This new PIN can be transmitted to the credit card company 16 in many ways, including utilizing a key pad provided at a merchant's location or utilizing the card holder's computer keypad to transmit this new PIN to the credit card company 16. This can be done by transmitting the previously used PIN used in combination with the formula used on file, for instance, “adding” with the secret digit or digits along with the new PIN. Thereafter, this new PIN is in the computer 24 used in combination with the formula and the end result is stored in the database and is ready for comparison for use in a new transaction 11 with another merchant 20 at Step 10. The PIN and the new PIN to be chosen will also be inserted all at one time.

Another manner in which the new PIN is generated without making a purchase. The card holder 14 through the use of Step 11 would, for example, check the balance of their credit card or debit card at for example, an independent keypad 22, all by calling a toll free number provided by the card company. At this point, once the new PIN is recorded, the next transaction can be consummated at Step 12 from a new merchant 20 or from the initial merchant 18 at Step 13. This embodiment is important, since if a new PIN is given to a merchant, that merchant could inform the user that a transaction was approved, when in reality the merchant would use the PIN with the credit card number to make their own purchase. Changing the PIN number in between use by calling a toll free number would prevent any potential fraudulent use by merchants. Additionally, when the credit card number is used back to back at the same location such as a secured area or with the same merchant, it is recommended to change the PIN in between these transactions. The user simply calls a toll free number from a cell phone after the transaction has taken place and changes the PIN. Hereafter the PIN is 100% secure and the system is fully fraudulent resistant.

Therefore, the teachings of the present invention would make it very difficult for a thief to utilize a card holder's credit or debit card or the card number for use on the internet since the secret digit or digits is only known by the individual credit card owner and the credit card company and is never ever given out. Consequently, if a thief would see the individual enter the PIN code, the subsequent use of that PIN code would be meaningless since he does not know the formula and the secret digit or digits. Therefore, even if a merchant would see the PIN code that was entered by the individual card holder at the merchant's terminal, the fraudulent use by that merchant of that PIN code could not be utilized to obtain approval for any subsequent transaction. If a thief picks up the new PIN code, he/she really does not have the next usable PIN code since he/she does not know what secret number to add on or subtract from to form the real new PIN. The PIN that was entered as the new PIN is by itself worthless without further knowledge of the secret digit or digits. Since the secret digit or digits are never revealed, this system is virtually 100% fully fraud proof.

Additionally, if a thief would intercept the credit or debit card mailed by the credit card company, which also could include the initial PIN, the thief would be unable to utilize the credit card with the PIN for any transaction since the thief would not be in possession of the secret digit or digits and the formula to use it. It is noted that the secret digit or digits can be applied to the initial PIN or any subsequent PIN by any arithmetic computation, such as, but not limited to, addition, subtraction, multiplication or division.

The following example is to be used to explain the system of the present invention. Assuming that the individual credit card owner has designated the number “24” as their secret digits and adding as preferred computation feature and, that when the credit card company has supplied the individual card holder with a particular credit or debit card, the company has also designated that the initial PIN to be 123. Then, at this point, the individual credit card owner can make a purchase using any means possible, such as visiting a merchant's establishment, contacting the merchant by telephone or through the internet. If the individual credit card owner is at the merchant's establishment. Once the individual credit card owner's card has been swiped at the merchant's terminal, the individual credit card owner would enter the number 147 based upon adding the secret digits “24” to the initial PIN 123. The number 147 would then be transmitted to the credit card company which would then check this number against the PIN stored in the credit card company's computer. The PIN stored in the computer is the last PIN or starter PIN with the secret digit or digits added on to it, in this case 147 was in memory. If there is a match, the purchase would be approved, if funds are available, and all other criteria are met.

When making a purchase, it is preferred that the individual credit card owner enter a new PIN. Generally, this number is entered after the old PIN which is the last PIN with the added secret digit or digits. Therefore, using the previously entered PIN of 147 (123+24), the individual credit card owner would enter a new PIN such as 666 which is transmitted to the credit card company's computer. This new number 666 is added to the secret digit 24 resulting in a new PIN of 690 (666+24). Thus, when the individual credit card owner wishes to make a second purchase, the number 690 would be entered. This number is then transmitted to the credit card company after which a comparison is made to the new PIN stored in the company's computer.

Prior to the next purchase made by the individual credit card owner, said owner would enter the number 690 plus any other number such as 111. This new number 111 when added to 24 would produce the next PIN, i.e. 135 and so on. The individual card holder can end this cycle by simply entering a preset number, such as the first number in the cycle which in this case is 123. This would block any initial utilization of the card since no new PIN is on file.

Another embodiment of the present invention would utilize the changing of each PIN by the individual card holder without the inclusion of the secret digit or digits. For example, if the initial PIN was 148, and if a purchase approved comparing this PIN with the PIN stored in the memory of the credit card company's computer. Before a second purchase is made, the individual credit card owner would enter the number 148 and any other number, such as 222. Prior to the next transaction, the individual credit card owner would enter 222 with a third PIN, such as 888 and so on. Additionally, although the present invention has been described with the utilization of a three digit PIN, the present invention is not so limited and the changeable PIN could include a number of digits as can the secret digit or digits.

While the present invention has been described with respect to particular embodiments, it can be appreciated that changes can be made to the invention within the proper scope of the description. For example, although the present invention has been described with respect to making different purchases or obtaining money from an ATM, any time a terminal is used to allow an individual to obtain something or to enter into a particular area, the use of a changeable PIN with or without the utilization of the secret digit or digits can be employed. Furthermore, the use of this invention to enter a security area, according to the present invention, can be accomplished even without the use of any identification card.

What is claimed is:

1. A method of utilizing a personal identification number comprising the steps of:
initially utilizing a first personal identification number by a user; and
said user generates a new personal identification number for every subsequent use.

2. The method in accordance with claim 1, further including the step of:
triggering an approval of each personal identification number when each personal identification number used with a predetermined formula of a secret digit or digits.

3. A method for approving a secured transaction between one or more parties, comprising the steps of:
creating a first PIN code consisting of one or more digits;
creating a second PIN code consisting of one or more digits;
creating a formula for the first and second PIN codes;
applying the formula on the first and second PIN codes resulting in the creation of a new PIN code;
storing said new PIN code;
comparing an incoming transaction with a PIN code with said new PIN code; and
approving or denying a transaction between parties, based upon said comparing step.

4. A method for approving a secure transaction between one or more parties, comprising the steps of:
comparing a PIN code stored in a database with an entered PIN code; and
entering a set of numbers generating a new PIN code and erasing the previous stored PIN code.

5. The method in accordance with claim 1, whereby a system separates part of the digits for comparison with the existing stored PIN code and the other part to be used to create a new PIN code.

6. A method for creating a secure transaction between a credit or debit card owner and a bank or credit card company, comprising the steps of:
opening an account with the bank or credit card company by said card owner;
creating an initial PIN stored in a database in communication with the bank or credit card company;
utilizing said initial PIN to make a first purchase through the credit card company or make a withdrawal from the bank;
comparing said initial PIN provided in said utilizing step with said initial PIN stored in said database;
approving said first purchase or withdrawal when said initial PIN in said utilizing step matches said initial PIN stored in said database;
transmitting a subsequent PIN to said database to replace said initial PIN in said database;
endeavoring to make a second purchase or withdrawal by said card owner by sending said subsequent PIN to said database;
comparing said subsequent PIN sent by said card owner when endeavoring to make said second purchase or withdrawal with said subsequent PIN stored in said database; and
approving said second purchase or withdrawal when said subsequent PIN supplied in said endeavoring step matches said subsequent PIN provided in said database.

7. The method in accordance with claim 6, wherein said subsequent PIN is transmitted to said database along with said initial PIN.

8. The method in accordance with claim 6, further including the step of said card owner initially supplying a secret digit or digits to said database to be applied to said initial and subsequent PINs stored in said database as well as to be applied to said initial PIN during said utilizing step.

9. The method in accordance with claim 8, further including the step of applying said secret digit or digits to said subsequent PIN in said transmitting step.

10. The method in accordance with claim 8, wherein said secret digit or digits are added to said initial and subsequent PINs.

11. The method in accordance with claim 8, wherein said secret digit or digits are subtracted to said initial and subsequent PINs.

12. The method in accordance with claim 8, wherein said secret digit or digits are multiplied by said initial and subsequent PINs.

13. The method in accordance with claim 8, wherein said secret digit or digits are divided into said initial and subsequent PINs.

14. The method in accordance with claim 8, wherein said secret digit or digits are added to said initial PIN and subtracted from said subsequent PIN.

15. The method in accordance with claim 1, wherein said first and new personal identification codes are entered or supplied all at once as one number.

16. The method in accordance with claim 3, wherein said first and second PIN codes are entered or supplied all at once as one number.

17. The method in accordance with claim 4, wherein said PIN code stored in the database and said entered PIN are entered or supplied all at once as one number.

18. The method in accordance with claim 6, wherein said initial PIN and said subsequent PIN are entered or supplied all at once as one number.

19. The method in accordance with claim 1, wherein said first and new personal identification codes are entered or supplied as two separate numbers.

20. The method in accordance with claim 3, wherein said first and second PIN codes are entered or supplied as two separate numbers.

21. The method in accordance with claim 4, wherein said PIN code stored in the database and said entered PIN are entered or supplied as two separate numbers.

22. The method in accordance with claim 6, wherein said initial PIN and said subsequent PIN are entered or supplied as two separate numbers.
